(19) United States
(12) Patent Application Publication
(10) Pub. No.: US 2014/0130367 A1
(43) Pub. Date: May 15, 2014

(54) SUPERCRITICAL DRYING DEVICE AND SUPERCRITICAL DRYING METHOD

(71) Applicant: Tsukasa Yonekawa, Tokyo (JP)

(72) Inventor: Tsukasa Yonekawa, Tokyo (JP)

(73) Assignee: DAI NIPPON PRINTING CO., LTD., Tokyo (JP)

(21) Appl. No.: 14/040,864

(22) Filed: Sep. 30, 2013

Related U.S. Application Data
(63) Continuation of application No. PCT/JP2012/058239, filed on Mar. 28, 2012.

(30) Foreign Application Priority Data
Mar. 30, 2011 (JP) 2011-076162
Jun. 30, 2011 (JP) 2011-146509

(51) Int. Cl. F26B 1/00

(52) U.S. Cl. CPC F26B 1/00
USPC 34/380; 34/60

(57) ABSTRACT

The purpose of the present invention is to make it possible to reuse drying retardant which was used for supercritical drying. A supercritical drying device is provided with a rinse unit (110) for cleaning a work piece with rinse solution (20) as a pre-process for supercritical drying, a supercritical drying unit (120) for performing the supercritical drying for the work piece cleaned with said rinse solution (20), and a transport unit (130) for transporting the work piece between said rinse unit (110) and said supercritical drying unit (120), wherein said supercritical drying unit (120) has an drying retardant supplying unit (140) for supplying drying retardant (30) including the same component as said rinse solution (20) and an drying retardant transportation unit (170) for collecting the drying retardant (30) supplied from said drying retardant supplying unit (140) to said supercritical drying unit (120) and transporting the drying retardant (30) collected from said supercritical drying unit (120) to said rinse unit (110), wherein the drying retardant (30) collected from said supercritical drying unit (120) is reused at least as a part of said rinse solution (20).

### TECHNICAL FIELD

The present invention relates to a supercritical drying device, in particular, the present invention relates to a supercritical drying device which can reuse a drying retardant used in supercritical drying.

### BACKGROUND ART

In a manufacturing process of a semiconductor device, after each process such as a lithography process, etching process and ion implantation process, cleaning and drying is performed in order to remove impurities remaining on a wafer surface or particles adhering to the wafer as a pre-treatment before moving to the next process.

In recent years, a very fine resist pattern or various fine three-dimensional structures using MEMS technology are formed on a wafer to produce high-density, high-performance devices including LSI. In the drying process after cleaning the semiconductor product described above, pattern collapse or pattern sticking may occur due to the surface tension of a cleaning solution than was removed simply by drying the remaining cleaning solution. In addition, in a three-dimensional structure produced by MEMS technology, there is also a possibility that sticking occurs in a height direction in the case of a hollow structure. As a result, there is a tendency to use a supercritical drying in which surface tension does not occur. Supercritical drying is a technique for drying a damage free product by replacing a liquid with a supercritical fluid having high diffusivity and solubility and subsequently vaporizing the supercritical fluid back to below a critical point. The example used in Patent Literature 1 can be given as a general supercritical drying technique.

In a supercritical drying process a series of cleaning and supercritical drying operations are performed in sequence. Although a wafer is cleaned with pure water, in the case of moving straight to supercritical drying after cleaning with pure water, when drying is performed in a state where the pure water remains within a pattern and the pattern is exposed above the dried wafer, an interface is created between a gas and liquid phase in minute spaces within the three-dimensional structure, stress is applied in the direction where the structure contracts by a capillary force due to interface tension of the pure water leading to a problem such as the occurrence of sticking. As the capillary force increases the surface tension of the liquid used for cleaning becomes larger making pattern collapse more easily to occur and therefore after rinsing with pure water, liquid substitution is performed using a liquid with a smaller surface tension than pure water such as IPA (isopropyl alcohol).

For example, in Patent Literature 1, a technique that performs liquid substitution by immersing a substrate within a transport pallet in which a chemical solution is immersed and transporting each transport pallet to a supercritical drying device is introduced.

At a stage previous to performing supercritical drying, a drying retardant is supplied to a wafer to ensure that no pattern collapse occurs when the wafer is dried in a drying chamber. Alcohol solvents such as IPA are widely used as the drying retardant.

A volatile organic compound (VOC) such as IPA is widely used in cleaning and drying. In recent years however, from the viewpoint of global environmental conservation, the emission of VOC is regulated requiring a reduction in the amount used. Therefore, technologies for reusing VOC have attracted attention. In addition, not only environmental protection but also in terms of cost, the reuse of IPA used as a drying retardant is problematic. However, reusing VOC in the supercritical drying device introduced in Patent Literature 1 is not considered.

### PRIOR ART LITERATURES

### Patent Literature

Patent Literature 1: Japanese Patent Application Laid-Open Publication No. 2003-109933

### SUMMARY OF INVENTION

Thus, the present invention has been arrived at in order to solve these problems and aims to provide a technique which performs liquefaction by reusing a drying retardant used in supercritical drying.

### Solution to Problem

A supercritical drying device according to an embodiment of the present invention includes a rinsing unit configured to clean a product using a rinsing liquid as a pretreatment for supercritical drying, a supercritical drying unit configured to perform supercritical drying of the product cleaned with the rinsing liquid, and a transport unit configured to transport the product between the supercritical drying unit and the rinsing unit, wherein the supercritical drying unit includes a drying retardant supply unit configured to supply a drying retardant including the same component as the rinsing liquid, and a drying retardant transport unit configured to collect the drying retardant supplied to the supercritical drying unit from the drying retardant supply unit and transport the drying retardant collected from the supercritical drying unit to the rinsing unit, wherein the drying retardant collected from the supercritical drying unit is used as at least a part of the rinsing liquid.

With this structure, it is possible to reuse the drying retardant which is used when performing supercritical drying, reduce the amount using a new rinsing liquid, and perform a supercritical drying process and a supercritical drying pre-process at low cost and low environmental pollution.

The rinsing unit may include a primary rising unit configured to perform a primary rinse, and a secondary rinsing unit configured to perform a secondary rinse in order to clean the product cleaned by the primary rinsing unit before transporting to the supercritical drying unit, wherein the drying retardant collected from the supercritical drying unit may use in the primary rising unit.

In this way, it is possible to reduce the amount used in a new rinse, and by only using a new rinse in the secondary rinse unit, it is possible to more reliably perform liquid replacement of rinsing liquid by rinsing several times and it is possible to provide a cleaner surface of the product after rinse cleaning.

In addition, a supercritical drying device according to another embodiment of the present invention includes a rinsing and transport unit configured to clean a product using a rinsing liquid as a pretreatment for supercritical drying and transport the product, a supercritical drying unit configured to perform supercritical drying of the product cleaned with the rinsing liquid, a drying retardant supply unit configured to supply a drying retardant including the same component as the rinsing liquid to the supercritical drying unit, and a drying retardant transport unit configured to collect the drying retardant supplied to the supercritical drying unit from the drying retardant supply unit and transport the drying retardant collected from the supercritical drying unit to the rinsing unit, wherein the drying retardant collected from the supercritical drying unit is used as at least a part of the rinsing liquid.

In this way, it is possible to reduce the amount used in a new rinse, and by only using a new rinse in the secondary rinse unit, it is possible to more reliably perform liquid replacement of rinsing liquid by rinsing several times and it is possible to provide a cleaner surface of the product after rinse cleaning.

The supercritical drying device may further include a water cleaning unit configured to water clean the product as a pretreatment to cleaning using the rinsing liquid, wherein a cleaning surface of the product is placed in a perpendicular state in the water cleaning unit, the rinsing unit and the transport unit remove the product from the water cleaning unit so that the cleaning surface is perpendicular and facing downwards, and subsequently the posture of the product is modified, the cleaning surface of the product is changed to a horizontal and upwards facing position and the product is transported.

In this way, it is possible to automatically change the posture of the product in the transport unit and prevent drying of the surface of the product by moving to a horizontal state.

In addition, the supercritical drying unit may include a processing unit configured to perform supercritical drying of the product internally, and a high pressure fluid supply unit configured to supply a high pressure fluid to the processing unit, the processing unit and the high pressure fluid supply unit are connected by a first tube, the processing unit and the drying retardant supply unit are connected by a second tube, the processing unit and the drying retardant transport unit are connected by a third tube, the interior of the processing unit, the first tube, the second tube and the third tube including a surface having an oxide film respectively.

In this way, the amount of metal discharged from the rinse and drying process unit and each tube is reduced, and thus the cleanliness level of the supercritical drying unit is maintained, and the spent drying retardant and product can be prevented from metal contamination within the rinse and drying process unit.

In addition, a supercritical drying device related to another embodiment of the present invention includes a supercritical drying unit configured to perform supercritical drying of a product, wherein the supercritical drying unit includes a rinsing and drying treatment unit configured to clean the product using a rinsing liquid as a pretreatment for supercritical drying and perform supercritical drying by supplying a drying retardant including the same component as the rinsing liquid after discharging the rinsing liquid, a drying retardant supply unit configured to supply the drying retardant including the same component as the rinsing liquid to the rinsing unit and the drying treatment unit, and a drying retardant transport unit configured to collect the drying retardant supplied to the rinsing unit and the drying treatment unit from the drying retardant supply unit and transport the drying retardant collected from the rinsing unit and the drying treatment unit to the rinsing unit and drying treatment unit, wherein the drying retardant collected from the rinsing and drying treatment unit is used as at least a part of the rinsing liquid.

In this way, it is possible to reuse the drying retardant as a rinsing liquid, it is not necessary to separately provide a space for rinse cleaning in the supercritical drying unit and it is possible to reduce the size of whole device.

In addition, the supercritical drying unit includes a high pressure fluid supply unit configured to supply a high pressure fluid to the rinsing unit and drying treatment unit, and a rinsing liquid supply unit configured to supply the rinsing liquid to the rinsing unit and the drying treatment unit, the rinsing unit and drying treatment unit are connected to the high pressure fluid supply unit by a first tube, the rinsing unit and drying treatment unit are connected to the drying retardant supply unit by a second tube, the rinsing unit and drying treatment unit are connected to the drying retardant transport unit by a third tube, the rinsing unit and drying treatment unit are connected to the rinsing liquid supply unit by a fourth tube, the interior of the rinsing unit and drying treatment unit, the first tube, the second tube, the third tube and the fourth tube including a surface having an oxide film respectively.

In this way, the amount of metal discharged from the rinse and drying process unit and each tube is reduced, and thus the cleanliness level of the supercritical drying unit is maintained, and the spent drying retardant and product can be prevented from metal contamination within the rinse and drying process unit.

In addition, a supercritical drying method related to another embodiment of the present invention includes cleaning a product using a rinsing liquid, transporting the cleaned product to a supercritical drying unit, supplying a drying retardant including the same components as the rinsing liquid to the supercritical drying unit and exposing the product to the drying retardant, filling the supercritical drying unit with a fluid in a supercritical state, replacing the drying retardant with the fluid in a supercritical state, subsequently vaporizing the fluid in a supercritical state and drying the product, and collecting the drying retardant supplied to the supercritical drying unit, and using the drying retardant as a part of the rinsing liquid when cleaning at least a separate product.

In this way, it is possible to reuse the drying retardant used in supercritical drying, and as a result it is possible to reduce the amount used in a new rinse, and perform a supercritical drying process and a supercritical drying pre-process at low cost and low environmental pollution.

The supercritical drying method may also include cleaning using a rinsing liquid includes a primary cleaning and a secondary cleaning, and the drying retardant is used as a part of the rinsing liquid when cleaning a separate product during the primary cleaning.

In this way, it is possible to reduce the amount used in a new rinse, and by only using a new rinse in the secondary rinse unit, it is possible to more reliably perform liquid replacement of rinsing liquid by rinsing several times and it is possible to provide a cleaner surface of the product after rinse cleaning.

In addition, a supercritical drying method relating to another embodiment of the present invention includes transporting a product to a supercritical drying unit while continuing to clean the product suing a rinsing liquid, supplying a drying retardant including the same components as the rinsing liquid to the supercritical drying unit and exposing the product to the drying retardant, filling the supercritical drying unit with a fluid in a supercritical state, replacing the drying retardant with the fluid in a supercritical state, subsequently vaporizing the fluid in a supercritical state and cleaning the product, and collecting the drying retardant supplied to the supercritical drying unit, and using the drying retardant as a part of the rinsing liquid when cleaning at least a separate product.

In this way, it is possible to reuse the drying retardant used in supercritical drying, and as a result it is possible to reduce the amount used in a new rinse, and perform a supercritical drying process and a supercritical drying pre-process at low cost and low environmental pollution.

The supercritical drying method may also include water cleaning performed on the product as a pretreatment to cleaning using the rinsing liquid, when water cleaning, a cleaning surface of the product is in a perpendicular state and subsequently the posture of the product is modified, the cleaning surface of the product is changed to a horizontal and upwards facing position and the product is transported.

Thus, it is possible to prevent drying of the surface of the product by moving to a horizontal state when transporting the product.

In addition, a supercritical drying method relating to another embodiment of the present invention includes cleaning a product in a supercritical drying unit using a rinsing liquid, discharging the rinsing liquid from the supercritical drying unit, supplying a drying retardant including the same components as the rinsing liquid to the supercritical drying unit and exposing the product to the drying retardant, filling the supercritical drying unit with a fluid in a supercritical state, replacing the drying retardant with the fluid in a supercritical state, subsequently vaporizing the fluid in a supercritical state and drying the product, collecting the drying retardant supplied to the supercritical drying unit, and using the drying retardant as a part of the rinsing liquid when cleaning at least a separate product.

In this way, it is possible to reuse the drying retardant as rinsing liquid, it is not necessary to separately provide a space for rinse cleaning in the supercritical drying unit, and it is possible to reduce the size of the whole device.

### Advantageous Effects of Invention

Using the present invention it is possible to reduce the amount of new rinsing liquid used, and perform a cleaning process in supercritical drying and a supercritical drying pre-process.

### BRIEF DESCRIPTION OF DRAWINGS

FIG. 1 is a block diagram showing the entire structure of a supercritical drying device related to one embodiment of the present invention;

FIG. 2 is a schematic diagram for explaining the structure of a supercritical drying unit of the supercritical drying device related to one embodiment of the present invention;

FIG. 3 is a schematic diagram for explaining a modified example of the structure of the supercritical drying unit of the supercritical drying device related to one embodiment of the present invention;

FIG. 4 is a block diagram showing a summary of the device when a pre-step of cleaning and rinsing with water is performed in the supercritical drying device related to one embodiment of the present invention;

FIG. 5 is a block diagram showing an example of arranging a plurality of rinsing units in the supercritical drying device related to one embodiment of the present invention;

FIG. 6 is a block diagram showing a summary of the supercritical drying device related to another embodiment of the present invention;

FIG. 7 is a schematic diagram for explaining the structure of a rinsing unit and a transport unit of the supercritical drying device related to another embodiment of the present invention;

FIG. 8 is a schematic diagram for explaining a modified example of the structure of a rinsing unit and a transport unit of the supercritical drying device related to another embodiment of the present invention;

FIG. 9 is a block diagram showing a summary of the supercritical drying device related to a third embodiment of the present invention;

FIG. 10 is a flowchart showing an example of a supercritical drying method related to another embodiment of the present invention;

FIG. 11 is a schematic diagram including a tube for explaining the structure of the supercritical drying device related to the first and second embodiments of the present invention;

FIG. 12 is a schematic diagram including a tube for explaining the structure of the supercritical drying device related to the third embodiment of the present invention;

FIG. 13 is a schematic diagram for explaining an example of a method of passivation treatment in the supercritical drying device related to the first and second embodiments of the present invention;

FIG. 14 is a schematic diagram for explaining an example of a method of passivation treatment in the supercritical drying device related to the third embodiment of the present invention;

FIG. 15 is a diagram for explaining an example of a method for supplying a rinsing liquid and drying retardant n the supercritical drying device related to the embodiment in FIG. 9; and

FIG. 16 is a block diagram showing a modified example of the supercritical drying device related to the embodiment in FIG. 9.

### DESCRIPTION OF EMBODIMENTS

The embodiments for carrying out the present invention are described below with reference to the accompanying drawings. Furthermore, the present invention is not to be limited to these embodiments and can be implemented by performing various modifications. In addition, in the drawings, in some cases there may be exaggerations such as width and height and may not accurately show the ratio between the actual width and height. Furthermore, the same reference numerals for components having similar functions and such explanations may be omitted.

### History to the Present Invention

In a supercritical drying process, when a VOC which is used as a drying retardant after rinsing and before supercritical drying is returned to a supercritical drying chamber and reused as a drying retardant, it was found that there is a possibility that particles contained in the reused drying retardant are attached to the wafer which is cleaned by rinse cleaning. As a result of intensive studies, the inventors of the present invention discovered that by reusing a drying retardant as a rinse cleaning liquid before a supercritical drying chamber or as a rinse cleaning liquid within a supercritical drying chamber, it is possible to reduce the amount of VOC used via cleaning and drying while maintaining a clean wafer.

### Embodiment 1

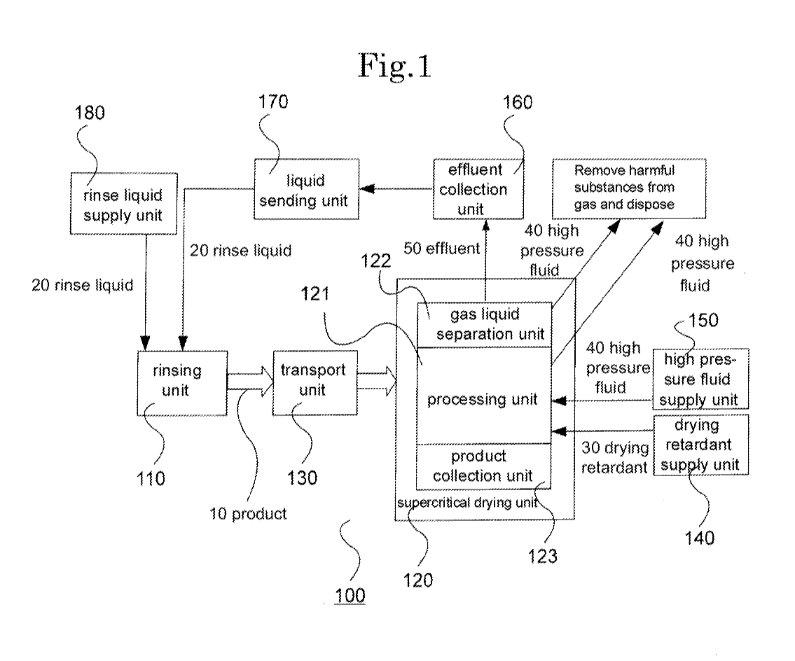

FIG. 1 is a block diagram showing the entire structure of the supercritical drying device related to one embodiment of the present invention.

Referring to FIG. 1, the supercritical drying device related to one exemplary embodiment of the present invention is arranged with a rinse unit 110, supercritical drying unit 120, a transport unit 130, a drying retardant supply unit 140, a high pressure fluid supply unit 150, an effluent collection unit 160, a liquid sending unit 170 and a rinsing liquid supply unit 180.

A product 10 undergoes a series of processes such as photolithography, etching, and ion implantation and is cleaned and dried. For example, an ultrafine patterned resist and fine spaces produced using MEMS technology are formed in the product 10. The product 10 is cleaned, transported and dried as it is or in a state of being supported in a product holder. When referring to the product 10 below, the product 10 also includes a product holder which supports the product 10. After being cleaned with pure water or after etching the product 10 is transported as it is to the rinsing unit 110. Furthermore, it is assumed that in the drawings and explanation below, the product is explained using sheet processing, however, a plurality of products may be batch processed collectively.

Rinsing unit 110 is a unit that performs rinsing of the product 10 using a rinsing liquid 20 as a pretreatment for supercritical drying. The rinsing liquid 20 is supplied from the rinsing liquid supply unit 180 and the liquid sending unit 170 to the rinse unit 110. The rinsing liquid 20 is a liquid with a smaller surface tension than normal pure water, and an alcohol solvent is often used. For example, IPA (isopropyl alcohol) is used as the rinse solution 20. The rinsing liquid supply unit 180 is normally connected to a tank containing the alcohol and supplies the rinsing unit 110 by sending the alcohol within the tank. The liquid sending unit 170 however, supplies the drying retardant used in supercritical drying to the rinse unit 110. This mechanism is described in detail below. In the rinse unit 110, the product 10 is cleaned using the rinsing liquid 20 and liquid replacement is performed using the rinsing liquid 20.

Product 10 which is cleaned by rinse unit 110 is transported to the supercritical drying unit 120 by the transport unit 130. Transport unit 130 is a general transfer robot arm and may be any mechanism as long as it can transport by stably grasping the product 10.

Supercritical drying unit 120 is a unit for performing supercritical drying of product 10. Supercritical drying unit 120 is arranged with at least a processing unit 121, a gas-liquid separation unit 122, and a product collection unit 123. The processing unit 121 is connected to the drying retardant supply unit 140, a high pressure fluid supply unit 150, and the gas-liquid separation unit 122, and the processing unit 121 and the gas-liquid separation unit 122 are connected to the discharge liquid collection unit 160.

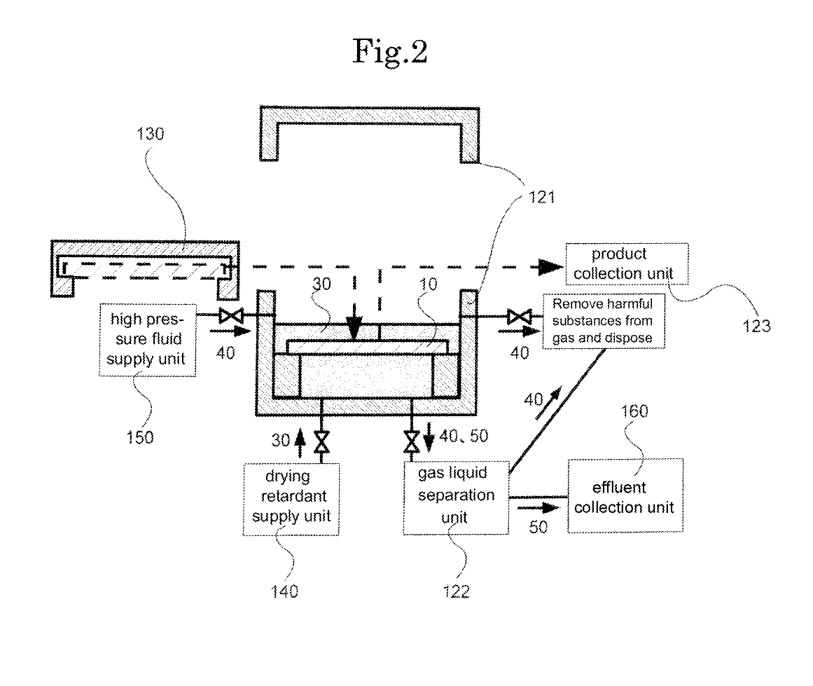

FIG. 2 is a diagram for explaining the structure of the supercritical drying unit of the supercritical drying device relating to one embodiment of the present invention. The details of the structure of the supercritical drying unit 120, drying retardant supply unit 140, the high-pressure fluid supply unit 150 and the discharge liquid collection unit 160 will be explained while referring to FIG. 2 in addition to FIG. 1.

The processing unit 121 is a pressure vessel (chamber) for performing supercritical drying of the product 10 within the processing unit 121. Referring to

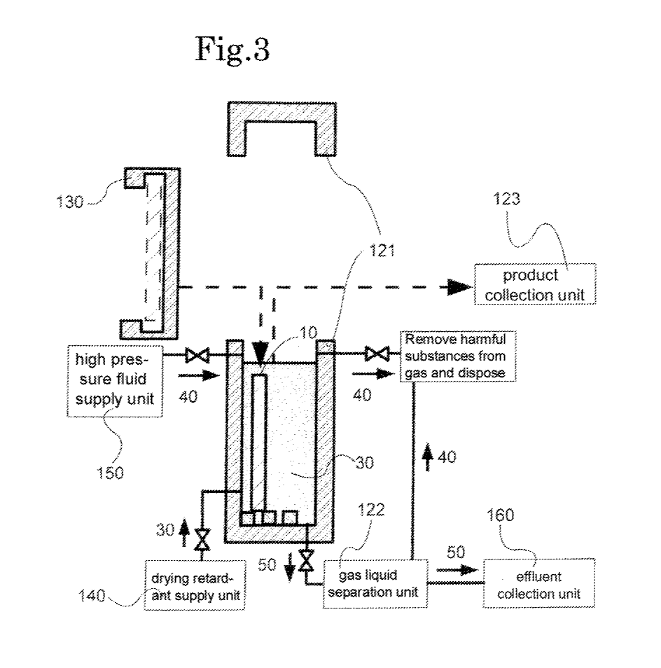

FIG. 2, when the product 10 is set in the processing unit 121 by the transport unit 130, the processing unit 121 is in an open state. When supercritical drying is performed of product 10 transported to the interior of the processing unit 121, processing unit 121 is in a closed state. Furthermore, although not shown in the diagram, after drying is completed, the processing unit 121 becomes open again, the product 10 is transported out of the processing unit 121 by the transport unit 130 and is stored in the product collection unit 123. In addition, the transportation of the product 10 may be performed by the transport unit 130 or may the product 10 may be sent by a separate transport means. As shown in FIG. 2, the product 10 is transported to the processing unit 121 in a state where the cleaned surface of the product 10 is in a horizontal state, and may be in a horizontal position, or as shown in FIG. 3, the product 10 may be transported to the processing unit 121 in a state where the cleaning surface is in a vertical position, and the product 10 may be vertical. Furthermore, the rinsing unit 110 can treat a plurality of products 10 and the processing unit 121 may be able to treat a plurality of the products 10, and may perform supercritical drying once of a plurality of the products 10 by batch processing.

The processing unit 121 is supplied with the drying retardant 30 from the drying retardant supply unit 140 through a tube. The drying retardant 30 usually has a smaller surface tension than pure water and a chemical solution having an affinity for a supercritical fluid is usually used. Furthermore, in the supercritical drying device related to one embodiment of the present invention, it is preferred that the same material as the rinsing liquid 20 is included. Considering the cost and handling properties, alcohol is desired to be used as the drying retardant 30 and rinsing liquid 20, for example, it is preferable to use IPA. In addition to the drying retardant, a chemical solution compatible with the chemical solution used for the drying retardant may be mixed with the rinsing liquid. By using a chemical solution including the same components as the rinsing liquid 20 in the drying retardant 30, it is possible to reuse IPA used as the drying retardant 30 as the rinsing liquid 20. in the present embodiment, the processing unit 121 is supplied with a clean drying retardant 30 from the drying retardant supply unit 140 for each product for performing supercritical drying.

The drying retardant 30 is supplied to the processing unit 121 so that a solvent interface of the drying retardant 30 is in a position higher than the upper surface position of the product 10 which is transported by the transport unit 130. In this way, it is possible to prevent pattern collapse or sticking occurring due to the product 10 drying before a high pressure fluid is supplied and replace the pure water remaining on the surface of the product 10, and prevent pattern collapse from occurring due to the interface tension of pure water at the interface of gas and a liquid phase.

In addition, the processing unit 121 is supplied with a fluid 40 which is in a liquefied state by high pressure from the high pressure fluid supply 150 through a tube. Fluid 40 may be any liquid which can be in a supercritical state by adjusting temperature and pressure. Among these, since the critical point of carbon dioxide is low 7.38 MPa, 31.1 C) and is chemically stable, it can be suitably used as a supercritical fluid. Furthermore, the fluid 40 may be supplied to the processing unit 121 in a supercritical state or may be in a supercritical state in the processing unit 121 after being supplied to the processing unit 121 in a liquefied state. Since there is a possibility that a part of the product 10 is damaged when carbon dioxide is introduced in a liquefied state and the drying retardant is flown to the product, it is desirable to introduce the carbon dioxide in a supercritical state to the processing unit 121.

Fluid 40 which is in a supercritical state continues to be dissolved from the vicinity of the interface of the drying retardant 30. The drying retardant 30 (including the fluid 40 in a supercritical state) is collected by the effluent collection unit 160 and discharged to the exterior of the processing unit 120 while further supplying the fluid 40. In this way, by supplying carbon dioxide in a supercritical state, the atmosphere around the product 10 is replaced by the carbon dioxide in a supercritical state from the drying retardant 30.

When the atmosphere around the product 10 is replaced with carbon dioxide in a supercritical state, the processing unit 121 is reduced in pressure. Carbon dioxide becomes a gas state by this pressure change and drying of the product 10 is completed. After collecting the carbon dioxide from the processing unit 121, the product 10 is transported to the exterior of the processing unit 121 by a product collection unit 123 and collected.

After supercritical drying, a liquid mixed with the high pressure fluid 40 and a part of the drying retardant 30 and gas becomes widespread within the processing unit 121. This mixture is collected from the processing unit 121 via a gas liquid separator 122. The gas liquid separator 122 collects this mixture within the processing unit 121 via a tube and valve for discharging an effluent in the processing unit 121.

In the gas liquid separator 122, a collected mixture is separated into gas and liquid. The gas liquid separation unit 122 for example is formed by 2 pairs of tubes and valves arranged in the processing unit 121. One is a tube and valve for discharging gas, and after supercritical drying the discharge gas produced as a result of opening a valve, that is the high pressure fluid 40 used in the supercritical drying and the drying retardant 30 in a gas state are discharged from the processing unit 121. The exhaust gas is discarded after removing harmful substances so as not to affect the air.

In addition, the other is a tube and valve for discharging effluent and effluent 50 is discharged from the processing unit 121 by opening the valve after supercritical drying. The contents of the effluent 50 mainly includes the drying retardant 30 used in the supercritical drying, and the high pressure fluid 40 and a small amount of particles or the like adhered to the product are mixed with the drying retardant 30. The effluent is sent to the effluent collection unit 160.

Effluent collection unit 160 collects the effluent sent from the gas liquid separation unit 122. For example, the effluent collection unit 160 may be a tank which accumulates the collected effluent 50. The effluent 50 is collected via a tube to the effluent collection unit 160 from the gas liquid separation unit 122. In the effluent collection unit 160, impurities may be removed from the effluent 50 by arranged a filter.

The liquid sending unit 170 includes a tube that connects the effluent collection unit 160 and rinse unit 110, and a mechanism for sending liquid collected in the effluent collection unit 160 to rinse unit 110, and sends effluent to the rinse unit 110 from the effluent collection unit 160 via the liquid sending unit 170.

The transport unit 130 transports the product 10 placed in the rinse unit 110 to the processing unit 121 of the supercritical drying unit 120 and is placed in the processing unit 121. The transport unit 130 rapidly transports the product 10 to the processing unit 121 so that product 10 is moved to the processing unit 121 by the time the surface of the product 10 which has been cleaned by a rinsing liquid dries.

The transport unit 130 may also transport the product 10 to the rinse unit 110 from the device in the previous step.

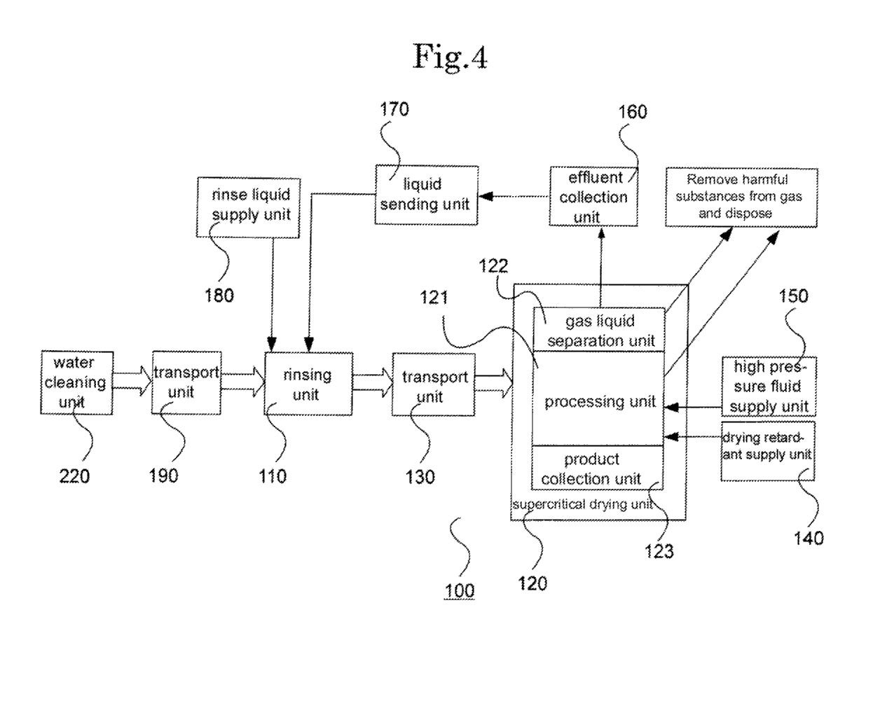

FIG. 4 is a block diagram showing a summary of the device when water cleaning is performed as a pre-step to rinsing in the supercritical drying device related to one embodiment of the present invention.

Referring to FIG. 4, a water cleaning unit 220 which performs the pre-process of the rinse unit 110 and a transport part 190 for transporting the product to the rinse unit 110 from the water cleaning unit 220 are included in addition to the structure referenced in FIG. 1.

In the water cleaning unit 220, the product 10 is cleaned using pure water. In the water cleaning unit 220, the product 110 cleaned with pure water is removed of particles and the like. In addition, cleaning with pure water also prevents drying of the product 10. The water cleaning unit 220 may batch treat a plurality of products 10.

The product 10 which is cleaned in water cleaning unit 220 is transported to the rinse unit 110 by the transport unit 190. It is desirable that the transport unit 130 mentioned above is used as the transport unit 190. This is because it is possible to achieve small scale across the entire device by utilizing a common transport unit. The supercritical drying device described above may be systematized including the water cleaning unit 220.

It is possible to reuse the drying retardant 30 which is used in the processing unit 121 in the rinse unit 110 by using the supercritical drying device according to the present embodiment, reduce the amount using a new rinsing liquid, and provide a supercritical drying device at low cost and low environmental pollution. In addition, while the supercritical fluid has an advantage of low viscosity that does not damage a pattern, its ability to remove particles is low. In the processing unit 121 in the present embodiment, because a clean drying retardant 30 is supplied from the drying retardant supply unit 140 for each product to be dried, the present embodiment also has excellent cleaning properties in addition to low cost as described above.

In the supercritical drying device related to the present embodiment, the product 10 may be rinsed several times by arranging a plurality of rinse units 110. It is also possible to reuse the drying retardant only for rinse cleaning in one of these rinse units. Performing rinse cleaning multiple times in a rinse unit 110 is explained below.

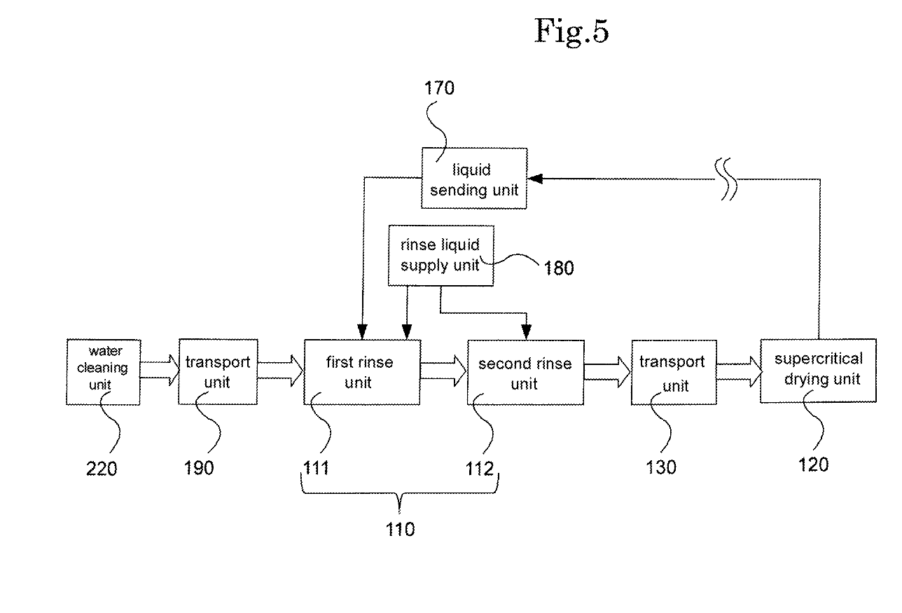

FIG. 5 is a block diagram showing an example in which a plurality of rinse units are arranged in the supercritical drying device related to one embodiment of the present invention.

Referring to FIG. 5, in the supercritical drying device of FIG. 5, a first rinse unit 111 for performing a primary rinse and a second rinse unit 112 for performing a secondary rinse are arranged as the rinse unit 110. The liquid sending unit 170 is connected to the first rinse unit 111, but is not connected to the second rinse unit 112. The collected drying retardant can be used in either the first rinse unit 111 or the second rinse unit 112, however, in the case where rinse cleaning is performed several times, rinse liquid 20 used for post rinsing is desired to be used in the first rinse unit 111 since it is cleaner. By using the structure of FIG. 5, in the first rinse unit 111, it is possible to reduce the amount of new rinse liquid used by using the effluent 50 sent by liquid sending unit 170, it is possible to more reliably liquid substitute the rinse liquid 20 from pure water by rinsing several times using only the new rinsing liquid in the second rinse unit 112, and it is possible to provide the product 10 with a clean surface after rinse cleaning.

The transport unit 130 described above is used in the case of transporting the product 10 between the first rinse unit 111 and the second rinse unit 112, and a different transport unit may also be used. It is desirable to be able to achieve small scale of the entire device if the transport units are used in common.

Furthermore, in the present specification, the primary rinse and the secondary rinse are named according to the cleanliness level of the product. The secondary rinse refers to a rinse with the highest level of cleanliness performed immediately before transporting the product to the supercritical drying unit 120, and the primary rinse refers to overall rinse cleaning prior to the secondary rinse. Therefore, the primary rinse unit may further include a plurality of rinse units.

### Embodiment 2

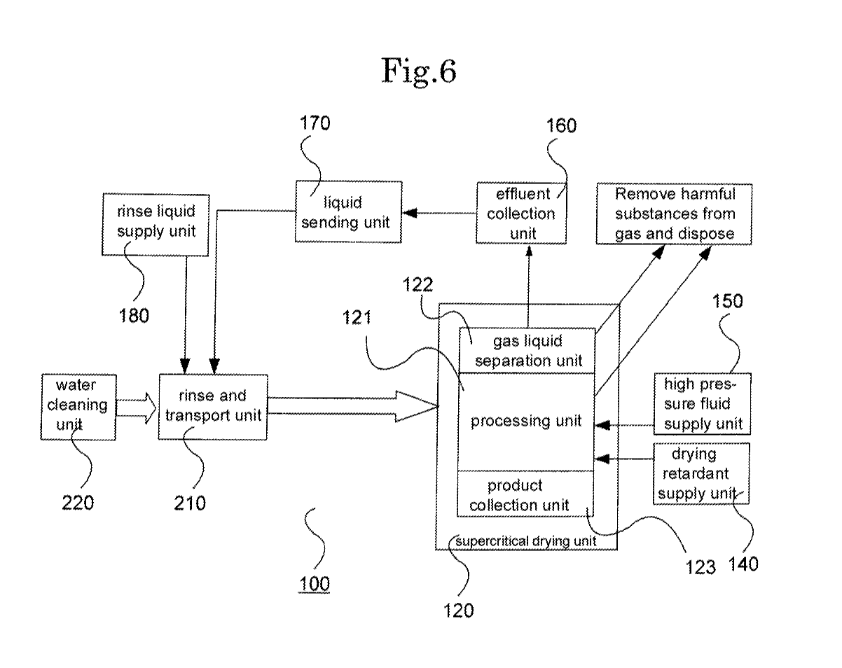

The structure of the supercritical drying device related to another embodiment of the present invention will be described below with reference to FIG. 6. In addition, a detailed explanation of the structure similar to the supercritical drying device related to the embodiment described above will be omitted.

FIG. 6 is a block diagram showing a summary of the supercritical drying device related to another embodiment of the present invention.

Referring to FIG. 6, the transport unit 210 and the rinsing, supercritical drying unit 120, drying retardant supply unit 140, the high pressure fluid supply 150, supercritical drying device according to another embodiment of the present invention, discharged liquid collection unit and a 160, the cleaning liquid 220 170, and rinsing liquid supply unit 180, to place. In the supercritical drying device according to another embodiment of the present invention, a transfer unit 130 and rinse unit 110 of Embodiment 1 embodiment described above are integrated, constituting the transport unit 210, and rinsed.

Liquid sending unit 170 and rinse liquid supply unit 180 send the rinse liquid to rinse and the transport unit 210.

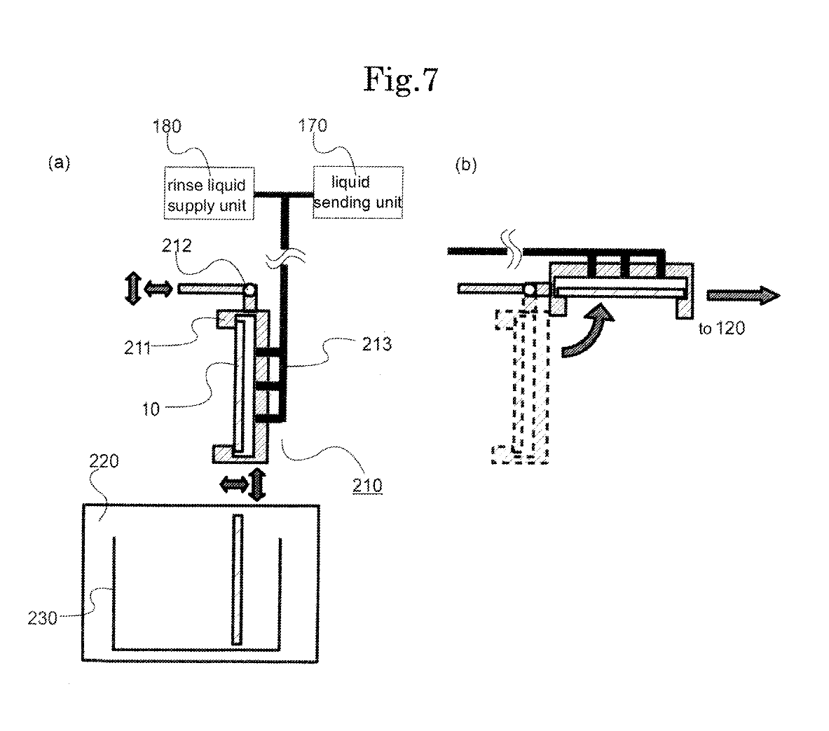

A detailed structure of the rinse and transport unit 210 is described with reference to FIG. 7.

FIG. 7 is a schematic diagram for explaining the structure of the rinse and transport unit 210 in the supercritical drying device related to another embodiment of the present invention, FIG. 7(A) is a schematic diagram for explaining an operation of raising the product 10 from the water cleaning unit 220, and FIG. 7 (B) is a schematic diagram for explaining a transport operation while rinsing the product 10.

Referring to FIG. 7 (A) and (B), the rinse and transport unit 210 include a product grip unit 211, a rotation mechanism 212 and a tube 213. The product 10 is mechanically gripped by the product grip unit 211. The posture of the product 10 gripped by the product grip unit 211 is changed by the rotation mechanism 212. A rinse liquid supplied from the rinse liquid supply unit 180 and liquid sending unit 170 are fed to the product 10 by tube 213.

Referring to FIG. 7(A), the product 10 is allowed to rest in a perpendicular state (the cleaning surface is perpendicular to the horizontal plane) in the water cleaning unit 220, and is raised upward in this state. In the case where product 10 is a wafer, the product 10 may be placed in a wafer carrier 220 within the water cleaning unit 220. While the product 10 is raised upward, the rinse liquid is supplied to the product 10 from the tube 213 and liquid replacement is performed from pure water to alcohol. Because pure water tends to flow downward due to gravity, it is possible to efficiently perform liquid replacement by placing the product 10 in a perpendicular position. Although it is preferred that the product 10 is placed in a perpendicular state in order to perform alcohol replacement from the pure water while the product is raised upwards, the present embodiment is not limited to this. That is, it is possible to raise thee product 10 upward with the cleaning surface pointing downwards so that pure water flows downwards. For example, the product 10 may be raised upward with the cleaning surface pointing downward at an angle in the range of 30±from the perpendicular state.

Next, referring to FIG. 7(B), after the product 10 is raised from the water cleaning unit 220, the product grip unit 211 is rotated by the rotation mechanism 212, and the product is moved from a perpendicular state to a horizontal state facing upwards (cleaning surface is parallel to the horizontal plane). Usually, in the processing unit 121 of the supercritical drying unit 120, because the product 10 is placed in a horizontal state, it is possible to transport the product 10 smoothly to the supercritical drying unit by changing the posture of the product 0 to a horizontal state during in the rinsing process. Therefore, by performing cleaning during transport to the supercritical drying unit 120 in a horizontal state, it is possible to reduce the processing time required for cleaning and transporting the product 10. In addition, by transporting the product 10 in a horizontal state, it is possible to prevent the product 10 from drying while being transported by allowing rinsing liquid to remain on the surface of the product 10. During transport of the product 10, although it is preferred that the product 10 is in a horizontal state with the cleaning surface facing upwards to more effectively prevent drying by the rinsing liquid, the present embodiment is not limited to this. That is, it is possible to transport the product 10 with the cleaning surface facing upwards so that the rinsing liquid easily flows downward. For example, the product 10 may be transported with the cleaning surface pointing upwards at an angle in the range of ±30 from the horizontal state with the cleaning surface facing upwards. Furthermore, although not shown in the diagram, a mechanism which can be extended in a horizontal direction can be arranged in the rinse and transport unit 210 thereby enabling movement of the product 10.

In this way, it is possible to easily enable automatic transport of a substrate. In addition, it is possible to reduce the size of the entire device by forming the rinse and transport unit 210 as a single unit rather than arranging a separate rinse and transport unit.

Furthermore, a structure may be adopted with either the first rinsing unit 111 and the second rinse unit 112 explained in the first embodiment used as the rinse transport unit 210, connecting both or one of these to the liquid sending unit 170 and reusing the drying retardant 30 as another embodiment similar to the second embodiment.

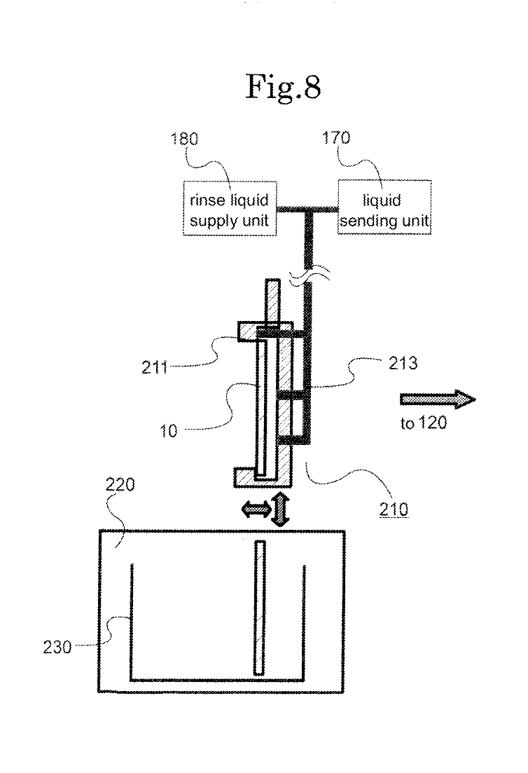

In addition, in the case where the product 10 is placed as it is in the supercritical drying unit 120 in a perpendicular position, as shown in FIG. 8, it is not necessary to arrange the rinse and transport unit 210 with the rotation mechanism 212 and the product 10 may be transported to supercritical drying unit 120 from the water cleaning unit 220 without changing the posture of the product 10. In the case where the product 10 is a wafer, one or more wafers may be transported to the supercritical drying unit 120 from the water cleaning unit 220 for each wafer carrier storing one or more wafers.

### Embodiment 3

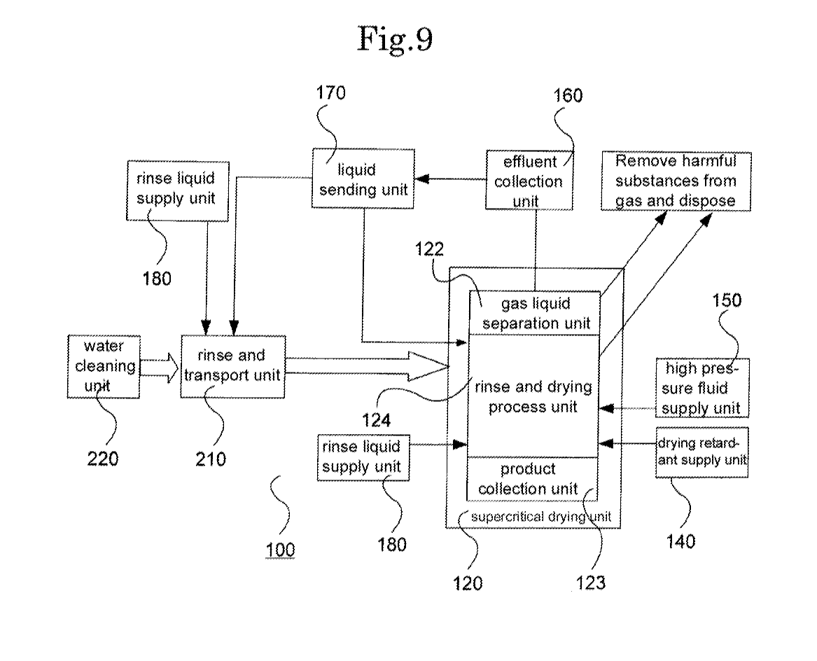

A supercritical drying device related to a third embodiment of the present invention is explained with reference to FIG. 9.

FIG. 9 is a block diagram showing a summary of the supercritical drying device related to a third embodiment of the present invention.

Details of the basic structure and each structure in FIG. 9 are the same as the first and second embodiments. However, while the processing unit 121 of the first and second embodiments is a rinse and drying process unit 124 which can also perform a rinse cleaning process, the third embodiment is different in that the rinse liquid 20 is supplied from the rinsing liquid supply unit 180 and liquid supply unit 170 to the rinse and drying process unit 124. Because the processing unit 121 performs rinse cleaning and supercritical drying, miniaturization of the device and simplification of a transport operation are expected.

In the present embodiment, the rinse and drying unit 124 includes a function that can also perform rinse cleaning internally in addition to the function of the processing unit 121. That is, specifically, the rinsing liquid 20 is supplied from the rinsing liquid supply unit 180 and the liquid supply unit 170 to the rinse and drying process unit 124. Furthermore, although the drying retardant 30 is supplied from the drying retardant supply unit 140, the rinsing liquid 20 and the drying retardant 30 may be liquids containing the same components.

In the rinse and drying process unit 124, rinse cleaning is carried out using the supplied rinsing liquid 20, and liquid replacement is carried out on the product 10 transported to the rinse and drying process unit 124.

After rinsing and cleaning is performed, the rinsing liquid 20 is discharged from the rinse and drying process unit 124 through the gas liquid separator 122 and collected by the effluent collection unit 160.

After discharge of the rinsing liquid 20, the drying retardant 30 is supplied to the rinse and drying process unit 124 a from the drying retardant supply unit 140. The subsequent processes are as described in the first and second embodiments. Furthermore, in the present embodiment, the rinse and transport unit 210 may also be the rinse unit 110 and the transport unit 130 in FIG. 9 or may contain neither structure, and the product 10 may be directly transported to the rinse and drying process unit 124 from the water cleaning unit 220.

Furthermore, it is also possible to reuse the collected effluent 50 as the drying retardant 30 in the rinse and drying process unit 124. However, when the effluent 50 used once during rinse cleaning and drying is used as the drying retardant 30, because there is a possibility that the product 10 may not be clean after the drying operation is, effluent 50 is not used as the drying retardant 30 in the present invention.

According to the present embodiment it is possible to reuse the drying retardant 30 as the rinsing liquid 20 in the rinse and drying process unit 124 and it is not necessary to separately provide a space for in the supercritical drying unit for performing rinse cleaning and thus the entire device can be reduced in size.

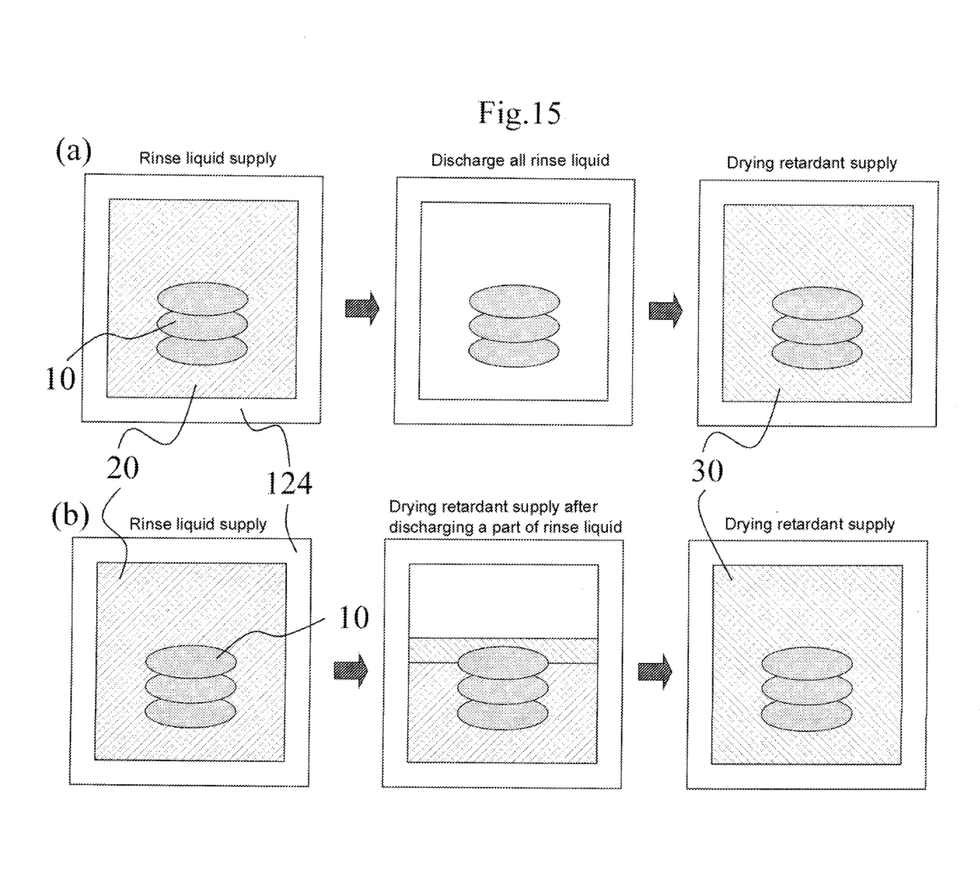

In the embodiment related to FIG. 9, as is shown in FIG. 15(a), the rinsing liquid 20 is first supplied to the rinse and drying process unit 124 set with the product 10 and liquid replacement is performed on the product 10. Following this, all of the rinsing liquid 20 is discharged from the rinse and drying process unit 124, the drying retardant 30 is supplied and the rinse and drying process unit 124 may be filled with the drying retardant 30. In addition, as shown in FIG. 15(b), the rinsing liquid 20 is first supplied to the rinse and drying process unit 124 set with the product 10 and liquid replacement is performed on the product 10. Following this, a part, half for example, of the rinsing liquid 20 is discharged from the rinse and drying process unit 124, drying retardant 30 is then supplied and the rinse and drying process unit 124 may be filled with the rinsing liquid 20 and the drying retardant 30. The supply method of the rinsing liquid 20 and the drying retardant 30 to the rinse and drying process unit 124 may change due to the level of cleanliness required for the product 10.

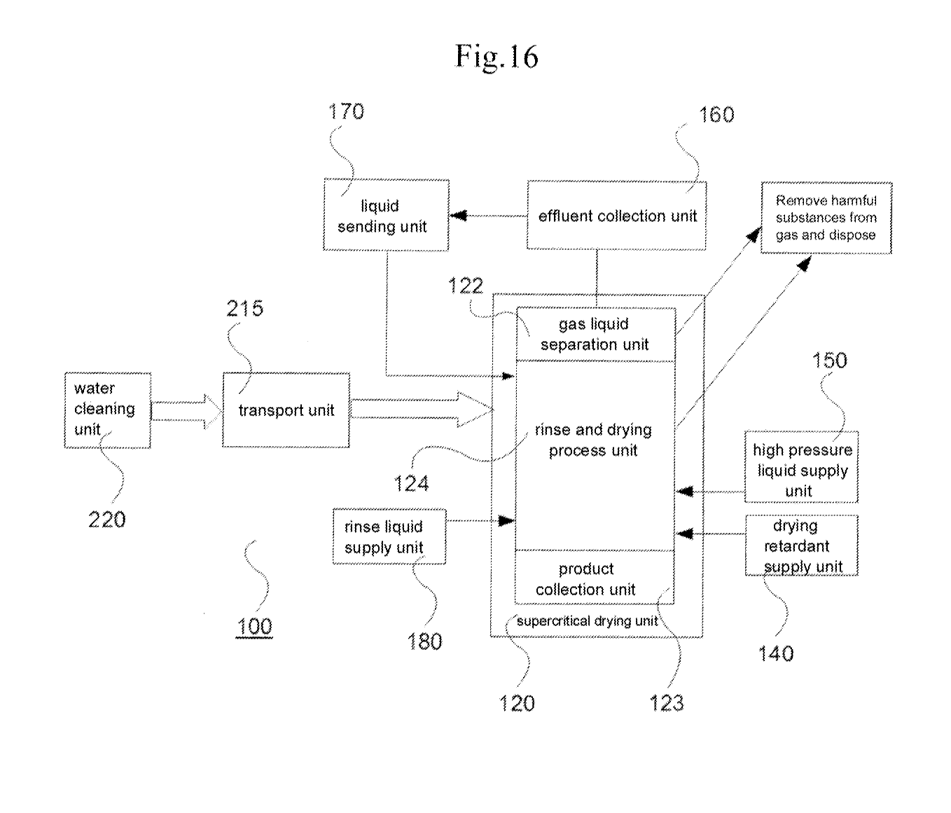

In addition, the supercritical drying device related to FIG. 16 is described as a modified example of the embodiment relayed to FIG. 9. With respect to a supercritical drying unit 120 which performs pre-processing to supercritical drying and the product 10 transported to the inside of the supercritical drying unit, the supercritical drying device related to FIG. 16 is arranged with a rinsing liquid supply unit 180 which supplies replacement liquid rinsing liquid) 20 for performing liquid replacement within the supercritical drying unit, a drying retardant supply unit 140 for preventing drying of the product as a pre-process to supercritical drying which is a post liquid replacement process, and supplies the drying retardant 30 containing the same component as the replacement liquid to the supercritical drying unit, an effluent collection unit 160 which collects the drying retardant 30 from the supercritical drying unit 120 and stores the collected drying retardant 30 as a part of the replacement liquid 20, and a liquid sending unit 170 which sends the collected drying retardant 30 to the supercritical drying unit 120 from the effluent collection unit 160 as at least one part of the replacement liquid 20 during the liquid replacement process. A transport unit 215 is also included instead of the rinse and transport unit 210 in FIG. 9. The structure of the transport unit 215 is the same as the transport unit 130 and the transport unit 190. Pure water and/or the rinsing liquid 20 may be supplied during transport by the transport unit 215. The collected effluent 50 is sent to the rinse and drying process unit 124 by the liquid sending unit 170 as the rinsing liquid 20. When sending from the liquid sending unit 170, a filter such as an adsorbent and the like may be arranged to remove impurities from the effluent 50. Furthermore, a tube may be arranged which sends the rinsing liquid 20 directly to the rinse and drying process unit 124, a tube may also be arranged which connects to the tube which sends the rinsing liquid 20 to the rinse and drying process unit 124 from the rinsing liquid supply unit 180, or a tube may be arranged with sends the rinsing liquid 20 to the rinsing liquid supply unit 180 as the structure of the piping when sending the rinsing liquid 20 to the rinse and drying process unit 124 from the liquid sending unit 170.

In the rinse and drying unit 124, first, liquid replaced is performed with rinsing liquid 20. Next, the rinsing liquid 20 used in the liquid replacement is discharged and discarded from the rinse and drying process unit 124. Then, after the drying retardant 30 is supplied to the rinse and drying process unit 124, the fluid 40 is supplied to the rinse and drying process unit 124 and supercritical drying is performed. After supercritical drying, the drying retardant 30 is discharged from the rinse and drying process unit 124 and the fluid 40 is discharged.

The tube connecting the rinse and dying process unit 124 and each structure with the rinse and drying process unit 124 may be subjected to a passivation treatment described below.

According to the present embodiment, it is possible to reuse the liquid 20 and the drying retardant 30 as the rinsing liquid 20, it is not necessary to separately arrange a space for performing rinse cleaning as the supercritical drying unit and it is possible to reduce the size of the entire device.

### Embodiment 4

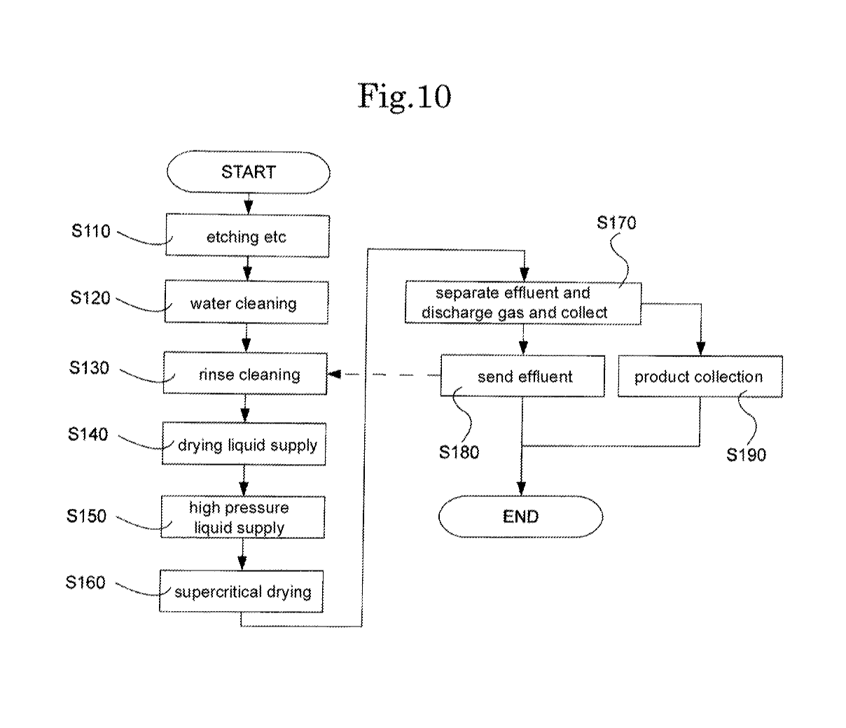

A supercritical drying method related to another embodiment of the present invention is described below while referring to FIG. 10. Furthermore, descriptions related to the contents that overlap with those described in the first to third embodiments are omitted.

FIG. 10 is a flowchart showing an example of the supercritical drying method related to another embodiment of the present invention.

First, pre-processing such as photolithography, etching, and ion implantation are carried out on the product 10 (S110).

Product 10 which has been subjected to pre-processing is transported to the water cleaning unit 220 by the carrier 230 or the like and is cleaned by immersing in pure water (S120). When immersing the carrier 230 in the cleaning unit 220, it is possible to reduce damage to a fine pattern by moving the cleaning surface of the product 10 to a perpendicular state.

The product 10 cleaned by pure water is cleaned using the rising liquid 20 in the rinsing unit 110 and the transport unit 210, and liquid replacement from pure water to the rinsing liquid is performed (S130). Liquid replacement may be performed several times. It is desirable that the product 10 is raised from the water cleaning unit 220 in a perpendicular state and changed to a horizontal state while continuing to supply the rinsing liquid.

The rinse cleaned product 10 is transported to the supercritical drying unit 120 by the transport unit 130 and the rinse and transport unit 210 and stored in the processing unit 121 in an open state. After the processing unit 121 stored with the product 10 is transferred to a closed state, the drying retardant 30 is supplied from the drying retardant supply unit 140, and the product 10 is prevented from drying before the supercritical drying process before (S140).

Furthermore, as described above, in the rinse and drying process unit 124, liquid replacement may be performed to a rinsing liquid d after transport by the transport unit 215 and the rinse and transport unit 210.

The fluid 40 is supplied to the processing unit 121 from the high-pressure fluid supply unit 150 (S150). The fluid 40 may be put in a supercritical state from a liquid state in advance or after being supplied. Because there is a possibility that a part of the product 10 may be damaged when the fluid is introduced in a liquid state and the drying retardant flows, it is desirable that the high pressure fluid 40 put into supercritical state in advance is introduced to the processing unit 121.

In the case where high pressure fluid 40 is introduced in a state which is not supercritical, the pressure and temperature are raised to a supercritical state within the processing unit 121. The fluid 40 in a supercritical state is gradually dissolved from the interface of the drying retardant 30. Supply of the fluid 40 and discharge of the drying retardant 30 are performed in parallel. Following this, the interior of the processing unit 121 is reduced to atmospheric pressure and the fluid is vaporized and drying is performed (S160).

After drying, in the gas-liquid separator 122, discharge gas is separated from the effluent 50 and the effluent 50 is collected in the effluent collection unit 160 (S170). Harmful substances are removed from the separated discharge gas.

The collected discharge effluent 50 is sent to the rinse unit 110 or the transport unit 210 via the liquid unit 170 (S180). The sent effluent 50 is used as a part of the rinsing liquid 20 when next cleaning the product 10. In addition, the product 10 which is dried is collected (S190).

Furthermore, as described above, the collected effluent 50 is sent to the rinse and drying process unit 124 via the liquid sending unit 170 and may be used as a part of the rinsing liquid 20 when next cleaning the product 10.

Using this series of processes, it is possible to reuse the drying retardant 30 used in the processing unit 121 in the rinse unit 110 or the rinse and transport unit 210, it is possible to reduce the amount of new rinsing liquid used, and it is possible to perform supercritical drying device at low cost and low environmental pollution.

### Embodiment 5

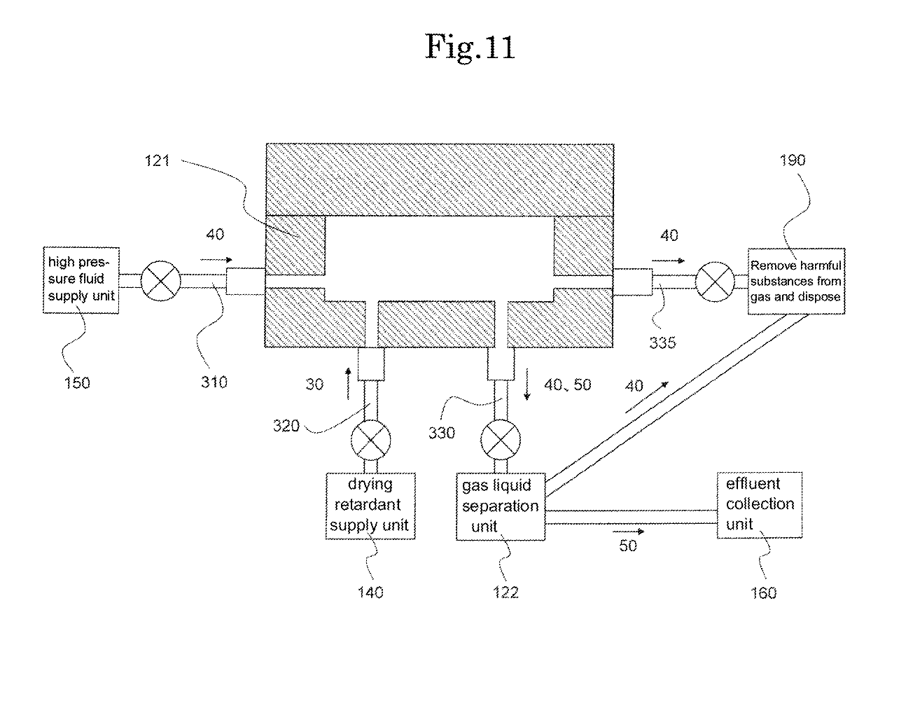

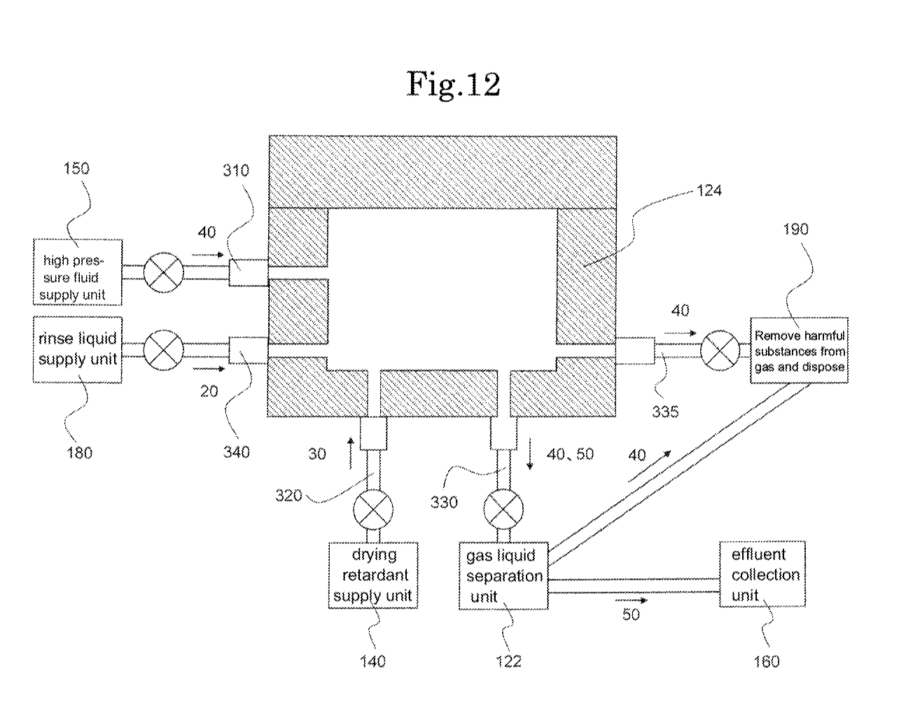

Next, a supercritical drying device related to a fifth embodiment of the present invention is explained while referring to FIG. 11 and FIG. 12. Before this, in order to simplify understanding of the supercritical device related to the fifth embodiment, the background leading to the present invention is briefly described.

In supercritical drying, a high pressure load is applied to a chamber and tube which guides a supercritical fluid to the chamber when using a supercritical fluid. Although stainless steel us is used for the chamber and tube, at this time, Fe, Cr, Ni or the like due to the stainless steel are discharged from the chamber and tube and metal contamination may occur due to the load exerted on the high pressure supercritical fluid. The present inventors propose subjecting the interior of the chamber and tube to a passivation treatment or the like to form an oxide film on the surface thereupon as follows.

### Passivation Process

In the present embodiment, a passivation treatment is performed on the tube that connects the rinse unit and the drying unit and each structure of the supercritical drying device. In particular, it is preferred that a passivation treatment is performed on the supercritical drying device related to each embodiment described above (first to fourth embodiments). A passivation treatment performed on the processing unit, tube that connects the rinse unit and the drying unit and each structure of the supercritical drying device related to each embodiment is explained below.

FIG. 11 is a schematic diagram including a tube for explaining the structure of the supercritical drying device related to the first and second embodiments of the present invention. In addition, FIG. 12 is a schematic diagram including a tube for explaining the structure of the supercritical drying device according to third third embodiment of the present invention. Apart from the tube in the first to third embodiments described above, an explanation of the details of each structure is omitted below.

Referring to FIG. 11, a high pressure fluid supply unit 150 and processing unit 121 are connected by a first tube 310. The high-pressure fluid 40 is supplied through the first tube 310 to the processing unit 121 from the high-pressure fluid supply unit 150.

The drying retardant supply unit 140 and the processing unit 121 are connected by a second tube 320. The drying retardant 30 is supplied through the second tube 320 to the processing unit 121 from the drying retardant supply unit 140.

Gas-liquid separation unit 122 and the processing unit 121 are connected by a third tube 330. Effluent 50 containing a fluid or gas discharged after supercritical drying is sent to the gas-liquid separation unit from the processing unit 121 through the third tube 330.

A block 190 for removing harmful substances from the gas and disposal and the processing unit 121 are connected by another tube 335. Gas 40 is sent to the block 190 through the tube 335.

Referring to FIG. 12, the supercritical drying device in FIG. 12 includes the rinse and drying process unit 124 instead of the processing unit 121 in FIG. 11. In addition, tubes 310, 320, 330 and 335 are connected between the rinse and drying processing unit 124 and the high-pressure fluid supply unit 150, the drying retardant liquid supply unit 140, the gas-liquid separation unit 122, and the block 190 for removing harmful substances from the gas respectively, which is the same as the supercritical drying device in FIG. 11.

In FIG. 12, a rinsing liquid supply unit 180 and the processing unit 121 are connected by a fourth tube 340. The rinsing liquid 20 is supplied through the fourth tube 340 to the rinse and drying process unit 124 from the rinsing liquid supply unit 180.

The processing unit 121 and the interior of the chamber of the rinse and drying process unit 124 are typically manufactured from stainless steel. In addition, stainless steel is also typically used as a material of each tube 310-340.

In the case where carbon dioxide for example is used as the fluid 40 , a pressure of about 12 MPa is applied to the rinse and drying process unit 124 and each tube 310-340, Fe, Cr, and Ni are discharged from the processing unit 121, the rinse and drying process unit 124 and each tube 310-340 which are made from stainless steel using this high pressure, and there is a possibility that the interiors of the processing unit 121, the rinse drying and processing unit 124, each tube 310-340 and the substrate surface become metal contaminated. If the interior of the process unit 121 becomes metal contaminated, the effluent 50 also becomes metal contaminated as a result after a supercritical drying process, and the rinsing liquid 20 becomes metal contaminated when the effluent 50 is reused as the rinsing liquid 20.

Therefore, in order to prevent the metals Fe. Cr, and Ni from being discharged from each structure, it is preferred that in the supercritical drying device related to each embodiment of the present invention, a surface process is performed on the processing unit 121, the rinse and drying process unit 124 and each tube 310-340, to prevent the discharge of metals by applying a coating on the interior surface of each structure. Here, a passivation treatment is preferred as the surface treatment in the case where each structure is formed of stainless steel.

The passivation treatment is performed by supplying ozone to the interior of the processing unit 121, the rinse and drying process unit 124, and each tube 310-340 to form an oxide film by oxidizing the Cr on the interior surface of each structure.

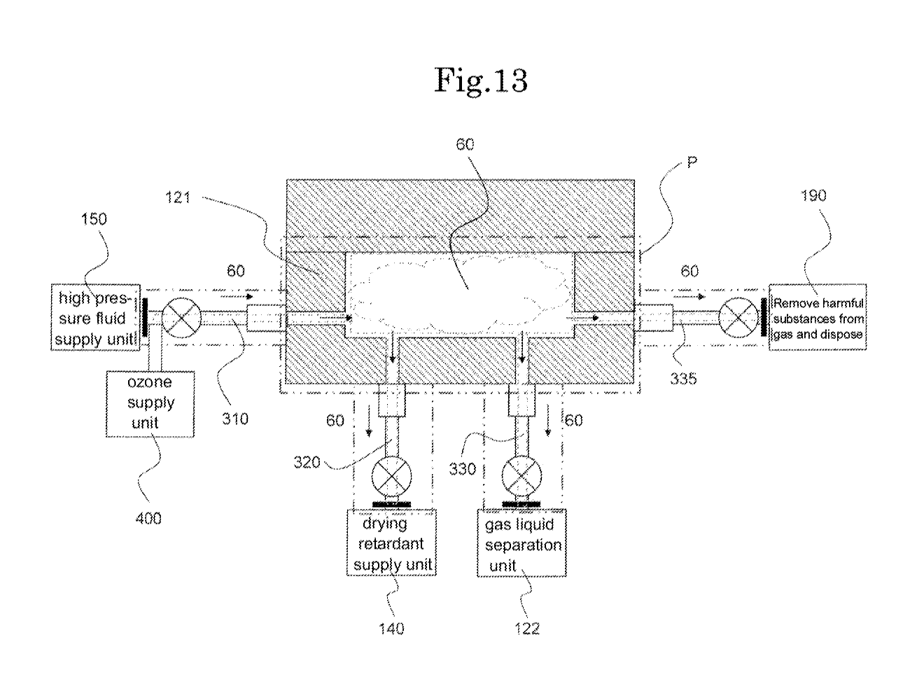

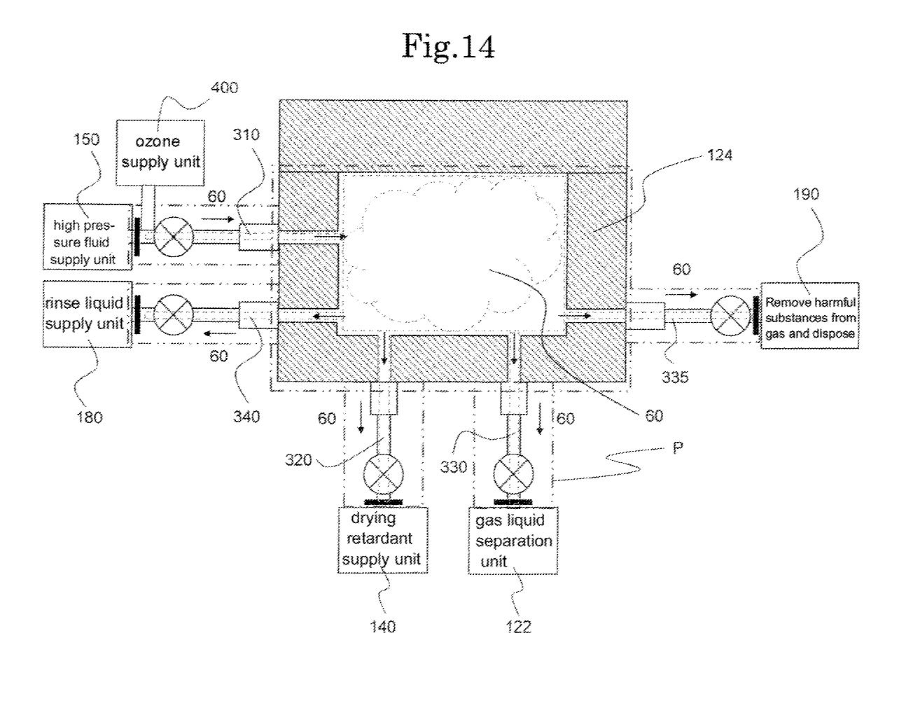

Next, an example of a method of a passivation treatment of the supercritical drying device in the first to third embodiments of the present invention is explained with reference to FIG. 13 and FIG. 14. FIG. 13 is a schematic diagram for explaining an example of the method of passivation treatment in the supercritical drying device related to the first and second embodiments of the present invention. FIG. 14 is a schematic diagram for explaining an example of the method of passivation treatment in the supercritical drying device according to the third embodiment of the present invention.

Referring to FIG. 13 and FIG. 14, instead of the high-pressure fluid supply unit 150, an ozone supply unit 400 is connected to the processing unit 121 and the rinse and drying process unit 124 through the first tube 310. When a stainless surface is exposed to ozone, an oxidation film is formed thereupon.

In FIG. 13 and FIG. 14, after connecting the processing unit 121 or the rinse and drying process unit 124 with each structure using each tube 310-340, ozone gas 60 compressed to a high concentration is supplied from the ozone supply unit 400. The ozone gas 60 is supplied to the processing unit 121 or the rinse and drying process unit 124 through the first tube 310, and to each tube 320-340 from the processing unit 121 or rinse and drying process unit 124. The end of each tube 320-340 is sealed, and the interior region P surrounded by a double chain line is exposed. In addition, unlike this structure, a part just before a valve of each tube 320-340 may be exposed to the ozone gas 60 by closing each valve.

The processing unit 121, rinse and drying process unit 124 and each tube 310-340 which are formed of stainless steel are exposed to the ozone gas 60 and as a result, an oxide film is formed on the inner surface of the stainless steel of each structure and the passive treatment is completed. The thickness of the oxide film is several nm. After the passivation treatment is completed, the ozone gas is discharged through the tube 335 to the block 190 to remove harmful substances and then disposed. Following this, the ozone supply unit 400 is replaced with the high pressure fluid supply unit 150 and supercritical drying is performed.

Using the passivation treatment described above, the amount of metal discharged from the rinse and drying process unit and each tube is reduced, and thus the cleanliness level of the supercritical drying unit is maintained, and the spent drying retardant and product can be prevented from metal contamination within the rinse and drying process unit. By preventing metal contamination of the spent drying retardant, it is possible use a cleaner rinsing liquid when reusing the rinsing liquid in the drying retardant.

### REFERENCE SIGNS LIST

100 supercritical drying device, 110 rinsing unit 110, 120 supercritical drying unit, 130 transport unit, 140 drying retardant supply unit, 150 high pressure liquid supply unit, 160 effluent collection unit, 170 liquid sending unit, 180 rinsing liquid supply unit

1. A supercritical drying device comprising:
a rinsing unit configured to dean a product using a rinsing liquid as a pretreatment for supercritical drying;
a supercritical drying unit configured to perform supercritical drying of the product cleaned with the rinsing liquid; and
a transport unit configured to transport the product between the supercritical drying unit and the rinsing unit;
wherein
the supercritical drying unit includes
a drying retardant supply unit configured to supply a drying retardant including the same component as the rinsing liquid; and
a drying retardant transport unit configured to collect the drying retardant supplied to the supercritical drying unit from the drying retardant supply unit and transport the drying retardant collected from the supercritical drying unit to the rinsing unit;
wherein
the drying retardant collected from the supercritical drying unit is used as at least a part of the rinsing liquid.

2. The supercritical drying device according to claim 1, wherein the rinsing unit includes a primary rising unit configured to perform a primary rinse, and a secondary rinsing unit configured to perform a secondary rinse in order to clean the product cleaned by the primary rinsing unit before transporting to the supercritical drying unit; wherein the drying retardant collected from the supercritical drying unit is used in the primary rising unit.

3. A supercritical drying device comprising:
a rinsing and transport unit configured to dean a product using a rinsing liquid as a pretreatment for supercritical drying and transport the product;
a supercritical drying unit configured to perform supercritical drying of the product cleaned with the rinsing liquid;
a drying retardant supply unit configured to supply a drying retardant including the same component as the rinsing liquid to the supercritical drying unit; and
a drying retardant transport unit configured to collect the drying retardant supplied to the supercritical drying unit from the drying retardant supply unit and transport the drying retardant collected from the supercritical drying unit to the rinsing unit;
wherein
the drying retardant collected from the supercritical drying unit is used as at least a part of the rinsing liquid.

4. The supercritical drying device according to claim 3 further comprising:
a water cleaning unit configured to water clean the product as a pretreatment to cleaning using the rinsing liquid;
wherein
a cleaning surface of the product is placed in a perpendicular state in the water cleaning unit, the rinsing unit and the transport unit remove the product from the water cleaning unit so that the cleaning surface is perpendicular and facing downwards, and subsequently the posture of the product is modified, the cleaning surface of the product is changed to a horizontal and upwards facing position and the product is transported.

5. A supercritical drying device comprising:
a supercritical drying unit configured to perform supercritical drying of a product;
wherein
the supercritical drying unit includes
a rinsing and drying treatment unit configured to clean the product using a rinsing liquid as a pretreatment for supercritical drying and perform supercritical drying by supplying a drying retardant including the same component as the rinsing liquid after discharging the rinsing liquid;
a drying retardant supply unit configured to supply the drying retardant including the same component as the rinsing liquid to the rinsing unit and the drying treatment unit; and
a drying retardant transport unit configured to collect the drying retardant supplied to the rinsing unit and the drying treatment unit from the drying retardant supply unit and transport the drying retardant collected from the rinsing unit and the drying treatment unit to the rinsing unit and drying treatment unit;
wherein
the drying retardant collected from the rinsing and drying treatment unit is used as at least a part of the rinsing liquid.

6. A supercritical drying method comprising:
cleaning a product using a rinsing liquid;
transporting the cleaned product to a supercritical drying unit;
supplying a drying retardant including the same components as the rinsing liquid to the supercritical drying unit and exposing the product to the drying retardant;
filling the supercritical drying unit with a fluid in a supercritical state, replacing the drying retardant with the fluid in a supercritical state, subsequently vaporizing the fluid in a supercritical state and drying the product; and
collecting the drying retardant supplied to the supercritical drying unit, and using the drying retardant as a part of the rinsing liquid when cleaning at least a separate product.

7. The supercritical device according to claim 1, wherein the supercritical drying unit includes a processing unit configured to perform supercritical drying of the product internally, and a high pressure fluid supply unit configured to supply a high pressure fluid to the processing unit, the processing unit and the high pressure fluid supply unit are connected by a first tube, the processing unit and the drying retardant supply unit are connected by a second tube, the processing unit and the drying retardant transport unit are connected by a third tube, the interior of the processing unit, the first tube, the second tube and the third tube including a surface having an oxide film respectively.

8. The supercritical device according to claim 2, wherein the supercritical drying unit includes a processing unit configured to perform supercritical drying of the product internally, and a high pressure fluid supply unit configured to supply a high pressure fluid to the processing unit, the processing unit and the high pressure fluid supply unit are connected by a first tube, the processing unit and the drying retardant supply unit are connected by a second tube, the processing unit and the drying retardant transport unit are connected by a third tube, the interior of the processing unit, the first tube, the second tube and the third tube including a surface having an oxide film respectively.

9. The supercritical device according to claim 3, wherein the supercritical drying unit includes a processing unit configured to perform supercritical drying of the product internally, and a high pressure fluid supply unit configured to supply a high pressure fluid to the processing unit, the processing unit and the high pressure fluid supply unit are connected by a first tube, the processing unit and the drying retardant supply unit are connected by a second tube, the processing unit and the drying retardant transport unit are connected by a third tube, the interior of the processing unit, the first tube, the second tube and the third tube including a surface having an oxide film respectively.

10. The supercritical device according to claim 4, wherein the supercritical drying unit includes a processing unit configured to perform supercritical drying of the product internally, and a high pressure fluid supply unit configured to supply a high pressure fluid to the processing unit, the processing unit and the high pressure fluid supply unit are connected by a first tube, the processing unit and the drying retardant supply unit are connected by a second tube, the processing unit and the drying retardant transport unit are connected by a third tube, the interior of the processing unit, the first tube, the second tube and the third tube including a surface having an oxide film respectively.

11. The supercritical device according to claim 5, wherein the supercritical drying unit includes a high pressure fluid supply unit configured to supply a high pressure fluid to the rinsing unit and drying treatment unit, and a rinsing liquid supply unit configured to supply the rinsing liquid to the rinsing unit and the drying treatment unit, the rinsing unit and drying treatment unit are connected to the high pressure fluid supply unit by a first tube, the rinsing unit and drying treatment unit are connected to the drying retardant supply unit by a second tube, the rinsing unit and drying treatment unit are connected to the drying retardant transport unit by a third tube, the rinsing unit and drying treatment unit are connected to the rinsing liquid supply unit by a fourth tube, the interior of the rinsing unit and drying treatment unit, the first tube, the second tube, the third tube and the fourth tube including a surface having an oxide film respectively.

12. The supercritical drying method according to claim 6, wherein cleaning using a rinsing liquid includes a primary cleaning and a secondary cleaning, and the drying retardant is used as a part of the rinsing liquid when cleaning a separate product during the primary cleaning.

13. A supercritical drying method comprising:
transporting a product to a supercritical drying unit while continuing to clean the product suing a rinsing liquid:
supplying a drying retardant including the same components as the rinsing liquid to the supercritical drying unit and exposing the product to the drying retardant;
filling the supercritical drying unit with a fluid in a supercritical state, replacing the drying retardant with the fluid in a supercritical state, subsequently vaporizing the fluid in a supercritical state and cleaning the product; and
collecting the drying retardant supplied to the supercritical drying unit, and using the drying retardant as a part of the rinsing liquid when cleaning at least a separate product.

14. The supercritical drying device according to claim 13, wherein water cleaning is performed on the product as a pretreatment to cleaning using the rinsing liquid, when water cleaning, a cleaning surface of the product is in a perpendicular state and subsequently the posture of the product is modified, the cleaning surface of the product is changed to a horizontal and upwards facing position and the product is transported.

15. A supercritical drying method comprising:
cleaning a product in a supercritical drying unit using a rinsing liquid;
discharging the rinsing liquid from the supercritical drying unit;
supplying a drying retardant including the same components as the rinsing liquid to the supercritical drying unit and exposing the product to the drying retardant;
filling the supercritical drying unit with a fluid in a supercritical state, replacing the drying retardant with the fluid in a supercritical state, subsequently vaporizing the fluid in a supercritical state and drying the product:
collecting the drying retardant supplied to the supercritical drying unit; and
using the drying retardant as a part of the rinsing liquid when cleaning at least a separate product.
